(19) United States
(12) Patent Application Publication
(10) Pub. No.: US 2001/0047305 A1
(43) Pub. Date: Nov. 29, 2001

(54) System and method for conducting business-to-business communications

(76) Inventor: Hubert A. Bowen JR., West Redding, CT (US)

Correspondence Address: CUMMINGS & LOCKWOOD, Granite Square, 700 State Street, P.O. Box 1960, New Haven, CT, 06509-1960, US

(21) Appl. No.: 09/780,024

(22) Filed: Feb. 10, 2001

Related U.S. Application Data
(60) Provisional application No. 60/181,819, filed on Feb. 11, 2000.
(60) Provisional application No. 60/264,830, filed on Jan. 29, 2001.

(51) Int. Cl. G06F 17/60

(52) U.S. Cl. 705/26

(57) ABSTRACT

The present invention provides a system and method for database communications between businesses. The system and method enables a first person to transmit product descriptions over a network of computers using an instant messaging system to a second person. In addition, the system and method enables the second person to select one or more of the transmitted product descriptions for storage in a database. Furthermore, the system and method enables businesses to readily manipulate product requests that received from other businesses soliciting buyers and sellers of products. Still Further, the system and method is easy to use and readily integrated into presently available systems and business routines.

### CROSS-REFERENCE TO RELATED APPLICATIONS

This application claims priority to provisional Patent Application Ser. No. 60/181,819, filed Feb. 11, 2000, entitled System And Method For Business-To-Business Communications and a provisional Patent Application Ser. No. (TBD), filed on Jan. 29, 2001, entitled Business-To-Business Communications System and Method. The applicant of both provisional Patent Applications is Hurbert A. Bowen, Jr.

### BACKGROUND OF THE INVENTION

1. Field of the Invention

The present invention relates generally to a system and method for business-to-business communications, and, more particularly, to a system and method which enables a first person to transmit items of database information over a network of computers using an instant messaging system to a second person or multiple people, and enables the second person or multiple people to select one or more of the items for storage in a database.

2. Background of the Related Art

Business-to-business commerce over the Internet is a substantial market that is growing day-by-day. It is anticipated that business-to-business transactions over the Internet will grow to $1.5 trillion dollars by the year 2005. Businesses utilize a variety of systems to conduct their business over the Internet. For example, businesses frequently e-mail other businesses in the same or a related industry that are interested in buying and selling particular products.

Using e-mail to conduct business has many advantages over the more traditional methods of communication such as regular mail, telephone, or facsimile. Some of the advantages include the ease and speed with which a message can be generated, transmitted and received. However, conducting business by e-mail also has a number of the disadvantages including, for example, the difficulty of manipulating the data in the e-mail after it is received and the inability to organize e-mails based on their content.

The problems associated with conducting business-to-business transactions using e-mail are compounded by the shear volume of e-mails transmitted between businesses. It is not unusual for a moderately sized business to transmit and receive a thousand e-mails in a single day from other businesses seeking buyers or sellers of products. The lack of a systematic method for handling the information leads to a substantial loss in revenue since leads are acted upon too slowly, in a haphazard fashion and, worse yet, never acted on at all.

Systems have been devised which are intended to automate transactions between buyers and sellers in businesses, however, they fall short in solving the above-described problems. These systems are little more than improved exchange systems intended to make information stored on a database more readily available to purchasers. As an example, Partminer, Inc., (New York, N.Y.) offers the Free Trade Zone™ web site (“FTZ site”), an online business-to-business procurement program for the purchase of electronic components. Generally, the FTZ site enables engineers and purchasing managers to research, source and buy electronic components over the Internet. An important aspect of the system is the generation and maintenance of the database of electronic components by Partminer.

In operation, a buyer logs onto the FTZ site, which is located at www.freetradezone.com, and gains access to three general areas: a “design center,” “shopping agent,” and a “marketplace.” The “design center” allows the buyer to conduct a search of an electronic components database by entering part numbers, manufacturers, keywords, or buyer-selectable criteria of component attributes and parameters.

The shopping agent allows the buyer to enter a series of part numbers or import a set of part numbers from an external application such as a spreadsheet. The buyer can then execute a search to extract component data from multiple web sites. This component data may include manufacturer part number, description, price, quantity available, manufacturer and supplier. The shopping agent simultaneously queries supplier web sites and displays those results in a table for comparing offerings in the market. The buyer can export these search results to a spreadsheet for analysis. Buyers can also select a line item related to a specific component and the shopping agent will link the buyer to the supplier's web site.

The marketplace allows buyers to issue requests for quotes (“RFQs”) to suppliers online. RFQs are automatically routed to the selected suppliers, who will be able to respond directly to the requesting buyer. The buyer is also able to negotiate online with the supplier and once the parties have reached agreement on terms, the buyer can generate a purchase order online.

The FTZ site improves the process of locating products over the Internet, however, it suffers from several disadvantages. One disadvantage relates to the loss of one of the most positive aspects associated with using e-mails, namely, the buyer and seller are not able to directly and candidly communicate with one another regarding their potential business transaction. A further disadvantage is that a buyer cannot easily manipulate product data within the program.

It is clear that a system and method is needed to assist buyers and sellers to conduct business over the Internet. Such a system should eliminate the disadvantages associated with transacting business using e-mail, however, retain the positive aspects thereof It is also clear that such a method must be relatively easy to use and readily integrated into presently available systems.

### SUMMARY OF THE INVENTION

The present invention provides a system and method for database communications between businesses. The system and method enables a first person to transmit product descriptions over a network of computers using an instant messaging system to a second person. In addition, the system and method enables the second person to select one or more of the transmitted product descriptions for storage in a database. Furthermore, the system and method enables businesses to readily manipulate product requests that received from other businesses soliciting buyers and sellers of products. Still Further, the system and method is easy to use and readily integrated into presently available systems and business routines.

### BRIEF DESCRIPTION OF THE DRAWINGS

So that those of ordinary skill in the art to which the subject invention pertains will more readily understand how to make and use the system and method described herein, preferred embodiments will be described in with reference to the drawings, wherein:

FIG. 1 is a block diagram illustrating a business-to-business communications system;

FIG. 2 is a block diagram of a business-to-business communications system that is similar to, although more detailed than FIG. 1;

FIGS. 3-5 illustrate contact, group and authenticate screens that are available in a manage contacts folder for an embodiment of the present invention;

FIG. 6 illustrates an authorization request window for an embodiment of the present invention;

FIG. 7 illustrates a manage products folder for an embodiment of the present invention;

FIG. 8 illustrates a manage broadcasts folder for an embodiment of the present invention;

FIG. 9 illustrates a send broadcast screen for an embodiment of the present invention;

FIG. 10 illustrates an instant-message screen for an embodiment of the present invention;

FIG. 11 illustrates an open incoming broadcast message in an incoming broadcasts folder for an embodiment of the present invention;

FIG. 12 illustrates an open incoming broadcast message in an incoming broadcasts folder for an embodiment of the present invention;

FIG. 13 illustrates a global send function in a global post folder for an embodiment of the present invention;

FIG. 14 illustrates a global search function in the global post folder for an embodiment of the present invention;

FIG. 15 is a flow chart depicting an embodiment of a server program for a business-to-business communications system;

FIG. 16 is a flow chart depicting an embodiment of a client program for a business-to-business communications system; and

FIG. 17 is a flow chart depicting an embodiment of a broadcast program for a business-to-business communications system.

### DESCRIPTION OF PREFERRED EMBODIMENTS

Reference is now made to the accompanying Figures for the purpose of describing, in detail, the preferred embodiments of the present invention. The Figures and accompanying detailed description are provided as examples of the invention and are not intended to limit the scope thereof

The present invention provides a novel and unique system and method for database communications between businesses. The system and method enables a first person to transmit product descriptions over a network of computers using an instant messaging system to a second person. In addition, the system and method enables the second person to select one or more of the transmitted product descriptions for storage in a database. Furthermore, the system and method enables businesses to handle the voluminous amount of product requests that they receive from other businesses soliciting buyers and sellers of products. Still Further, the system and method is easy to use and readily integrated into presently available systems and business routines.

Those skilled in the art will appreciate that the present invention may be successfully used in various levels of product distribution chains (e.g., wholesale, retail, etc.) and in practically any industry. The only criterion is that the products are commodities or have commodity-like characteristics.

The trademark TradeMail® identifies an embodiment of the inventive system and method for business-to-business communications that is disclosed herein. The mark is registered to the inventor and concerns computer software for buying and selling computer systems and components. This trademark is used herein when referring to the complete system, method, or programs therefor in order to facilitate the description of the preferred embodiments. The use of the trademark in this fashion is not intended to restrict the claims of the invention to any particular embodiment of the invention.

For the description that follows, the term “electronic message” shall refer to an instant-type message (“IM”), broadcast message, or an e-mail message, all of which may contain database information supporting the purposes of the present invention. The term “contact” shall refer to a person to which a broadcast message is to be sent.

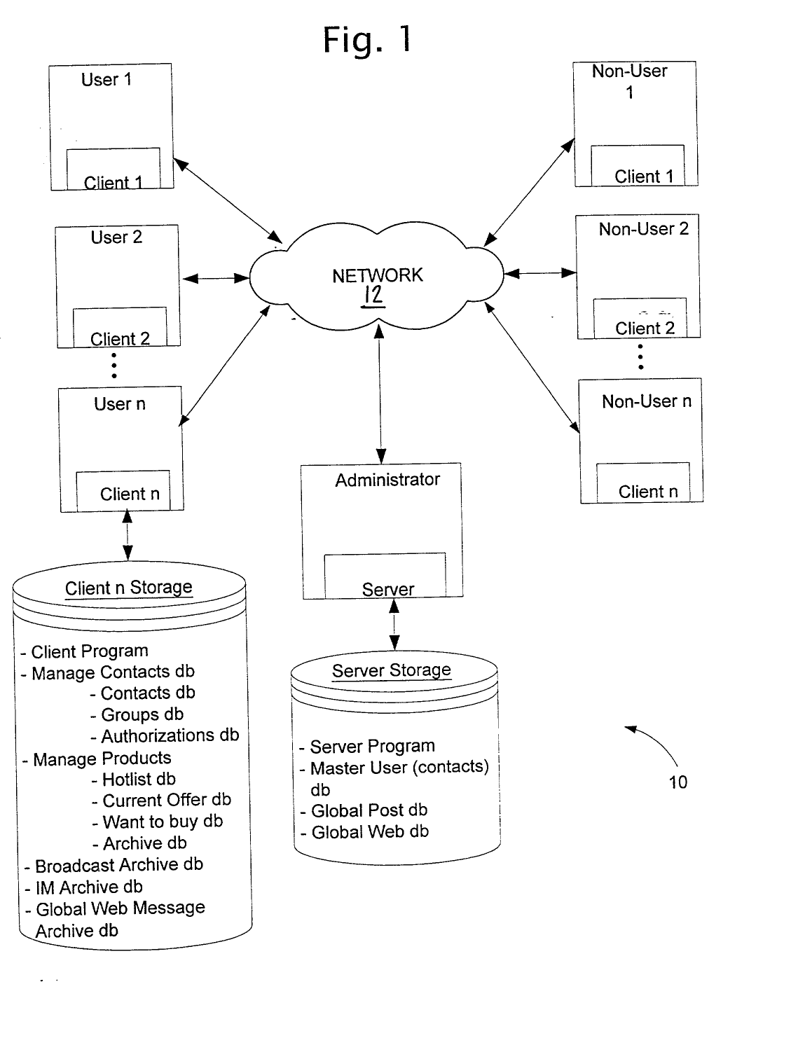

Referring to FIG. 1, there is illustrated a client/server network arrangement 10 wherein a network 12 such as the Internet forms the communication channel on which all information is transported between user clients 1 through n, non-user clients 1 through n, and a server. The client for each user includes a storage, wherein there is stored a client program, manage contacts databases, manage products databases, broadcast archive database, IM archive database, and a global web message archive database. The server includes a storage, wherein there is stored a server program, master user (contacts) database, global post database, and a global web database.

The term “user” shall refer to any person operating a client wherein there is stored the client program and related databases as described above. The term “non-user” shall refer to any person operating a standard client computer. The term “server” shall refer to a computer or group of computers, wherein there is stored the server program and related databases as described above, and is networked with one or more clients.

There are generally two software programs utilized in the TradeMail program, they are the TradeMail server cluster program (“server program”) and the TradeMail client program (“client program”). The server program is utilized by a TradeMail server cluster (“server cluster”) which functions as a central hub for the TradeMail system. The client program is a desktop database program that a user may download over a network from the server program or via compact disc. The client program includes databases that allows users to transmit database information back and forth between businesses via EPM and IM. All users of the TradeMail system have a copy of the client program. It is notable, however, that businesses that do not have a copy of the client program, i.e., non-users, may receive a broadcast message in e-mail format from a sending user that has a client program. An error message is provided to sending users for failed broadcast messages (e.g., time outs), IMs, and e-mails.

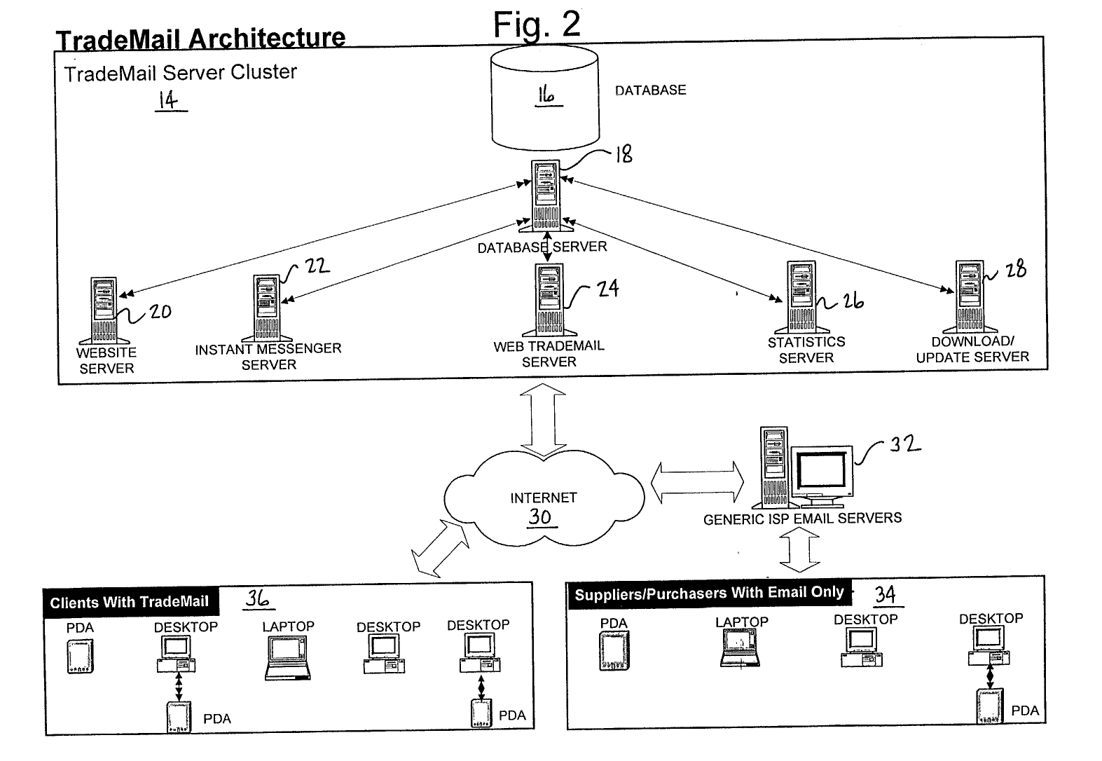

Referring to FIG. 2, the TradeMail system is shown to include a server cluster 14 that includes a database 16 that is in communication with a database server 18. The database server 18 manages the storage of information/data/programs that are important to the functionality of the TradeMail system. A Web-site server 20 is also in communication with the database server 18. The Web-site server 20 supports a global web site to which users may post products for users/non-users to purchase. Web-site server 20 may also support web sites for each individual user so they can post products separately in, for example, an electronic mall setting.

An instant messenger server 22 is also in communication with the database server 18. The instant messenger server 22 manages the transmission of instant messages to a multiple number of users without any downtime information saved to the database server 18. A Web TradeMail server 24 is also in communication with the database server 18. The Web TradeMail server 24 provides non-users access to a version of the client program for a limited period of time.

A statistics server 26 is also in communication with the database server 18. Because the server cluster 14 is a hub through which all broadcast messages are transmitted, the statistics server 26 can receive and store transmission data and calculate and store statistical data regarding transmissions by users/non-users. The statistical data may include, for example, the quantity and description of the products in all broadcast messages. The data is available to third parties such as computer manufacturers for evaluating markets for their goods. A download/update server 28 is also in communication with the database server 18. The download/update server 28 enables users to acquire broadcast messages and updates.

The TradeMail programs may be used over any computer network. For example, the TradeMail programs may be used over the Internet 30. Generic Internet service provider (“ISP”) e-mail servers 32 may be used to link suppliers/purchasers having e-mail only 34 with the server cluster through the Internet 30. Alternatively, clients having the client program 36 may communicate directly with the server cluster 14 using their client program.

The client program includes six basic components: a contact management component, product management component, broadcast management component, incoming broadcast management component, global post management component, and a global web management component. Each component is described in more detail herein below.

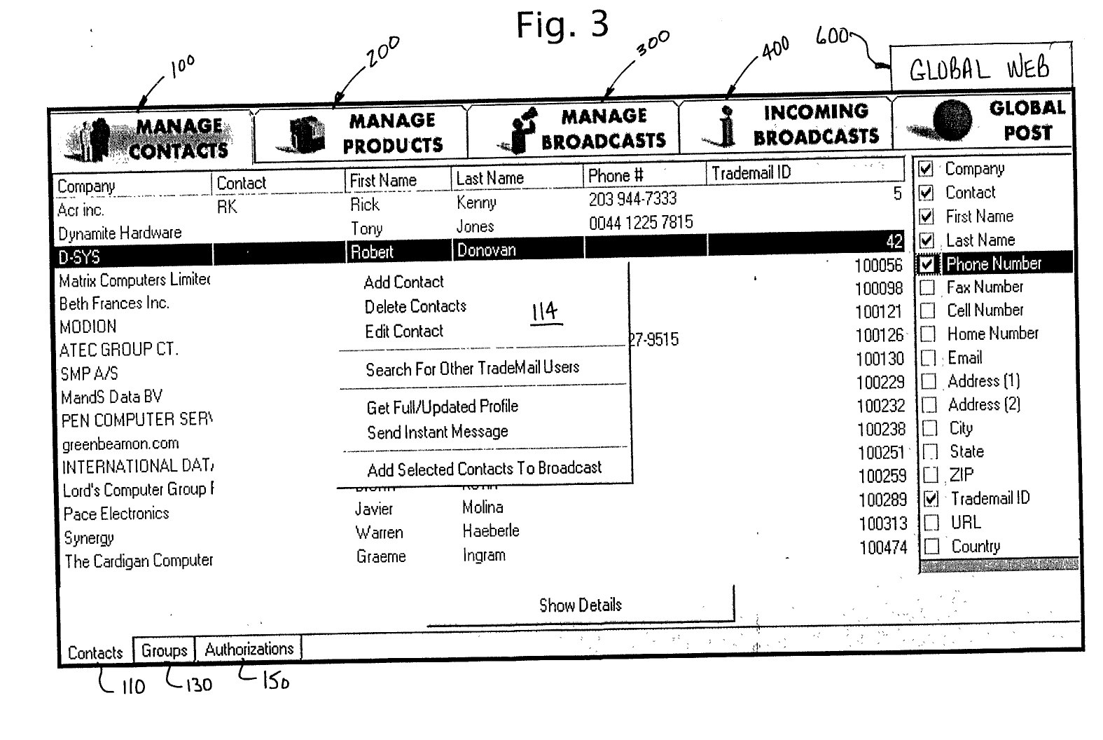

Referring to FIG. 3, an exemplary menu screen shows a folder for each of the six components, namely, manage contacts folder 100, manage products folder 200, manage broadcasts folder 300, incoming broadcasts folder 400, global post folder 500, and global web folder 600. Each folder is accessible to a user by clicking on the tab of the desired folder.

In the manage contacts folder 100 there is available a contacts screen 110, a groups screen 130, and an authorizations screen 150. The contacts screen 110 includes a list of names of previously entered contacts. The contacts screen 110 provides entry fields for data describing a user's contacts. The entry fields include detailed information concerning a contact. The fields are listed in a detail selection panel 112 on the right-hand side of the screen 110. A user can select the specific information he desires to display on the screen 110. The contacts screen 110 conveniently includes a “show details” control for showing all of the detailed information on a particular contact at one time for reviewing/editing.

In-depth contact profile information may also be stored in the contacts screen 110. For example, contact profiles may include such in-depth information as the size of the company, a brief history of the company, the owners of the company, the company's credit worthiness, other products sold by the company, and other industries in which they are involved. In addition, the contact screen 110 may facilitate the ranking of contacts based on the importance of their broadcast messages to the user. Therefore, when a broadcast message is received from a particular contact, it will be deposited in the incoming broadcast folder 400 according to a ranking given by the user.

A dropdown menu 114 is accessible for executing various functions including adding contacts to the contacts screen 110, deleting contacts from the contacts screen, searching for other TradeMail systems users, getting a full/updated profile of another user, sending an IM, and adding selected contacts to a broadcast message, the global post folder 500 or the global web folder 600. Contacts listed in the contacts screen 110 that are online at any given moment are high-lighted so a user always knows who is immediately available.

Including vendor contact information in each broadcast message is advantageous to users in a number of ways. For example, users benefit from receiving vendor contact information since they automatically receive the information regarding the vendor interested in buying or selling particular products. In addition, the information they receive is the latest information. Furthermore, since the contact profile may include in-depth information, the recipient user can better evaluate and monitor the type of contacts with which they are doing business. As supplier users and customer users send messages through the TradeMail system, their contact and profile information is updated automatically.

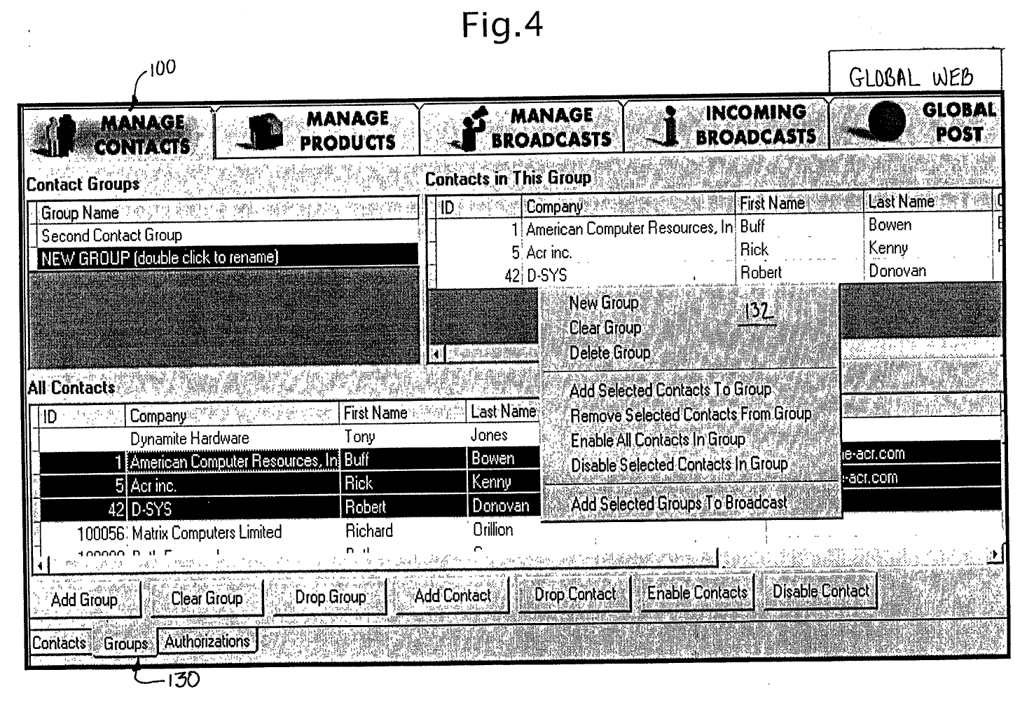

Referring to FIG. 4, the groups screen 130 enables a user to add/drop contact groups, add/drop contacts to/from a contact group, clear a group, and enable/disable a contact within a contact group. The groups can be identified by a group name selected by the user. The groups screen 130 conveniently includes several functions including an add-group function, clear-group function, drop-group function, add-contact function, drop-contact function, enable-contacts function, and a disable-contact function for performing the functions described above. The functions may also be accessed from a dropdown window 132. The dropdown window 132 also includes a function for including contacts that are enabled in selected groups to be added to a broadcast.

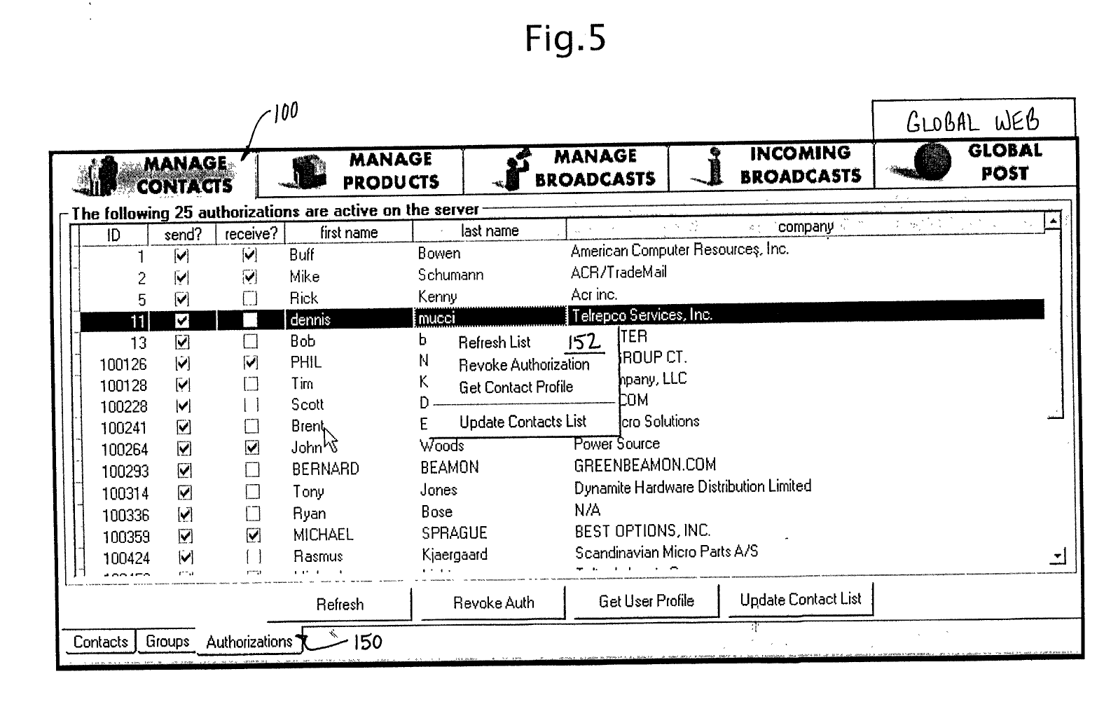

Referring to FIG. 5, the authorizations screen 150 enables a user to authorize the sending of broadcast messages to and the receiving of broadcast messages from a contact by checking the appropriate box next to the contact's name. A user may not want to authorize the sending of broadcasts to a contact because, for example, the contact has indicated that he does not desire to receive broadcasts. A user may not want to authorize the receiving of broadcasts from a contact because, for example, the contact sells products that the user is unable to sell, that is, for anti-spamming purposes. The authorization screen conveniently includes four functions including a refresh function, revoke authorization function, get-user-profile function, and an update-contact-list function. The functions may also be accessed from a dropdown window 152.

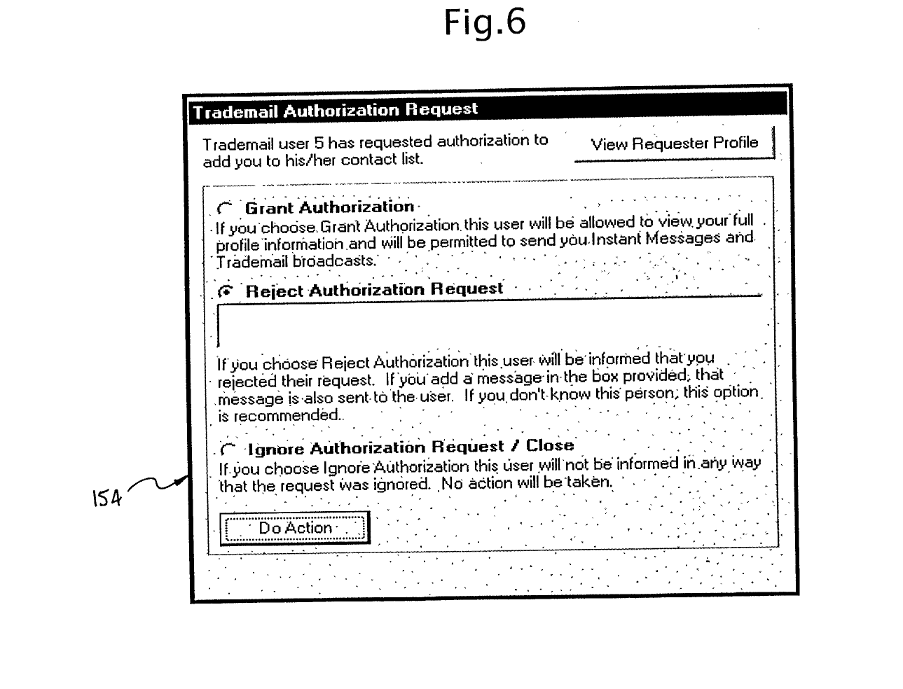

Referring to FIG. 6, authorization must be received from users before broadcasts can be transmitted to them. When an authorization is sought, an authorization request 154 is transmitted to the user from whom authorization is desired. The recipient of the request 154 is presented with three choices including “grant authorization,” “reject authorization,” and “ignore authorization request/close.” The grant authorization selection allows both parties to send/receive electronic messages and instant messages with one another as well as view and automatically update each parties profile information. The reject authorization selection informs requester that the recipient has rejected the recipient's request and may include a message prepared by the recipient why authorization was denied. The ignore authorization request/close does not inform requester that their request was ignored and no action is taken. Users receiving authorization requests may view the company profile of the requesting party. Once the authorization request is granted, the requester must add the new contact to his manage contacts folder 100.

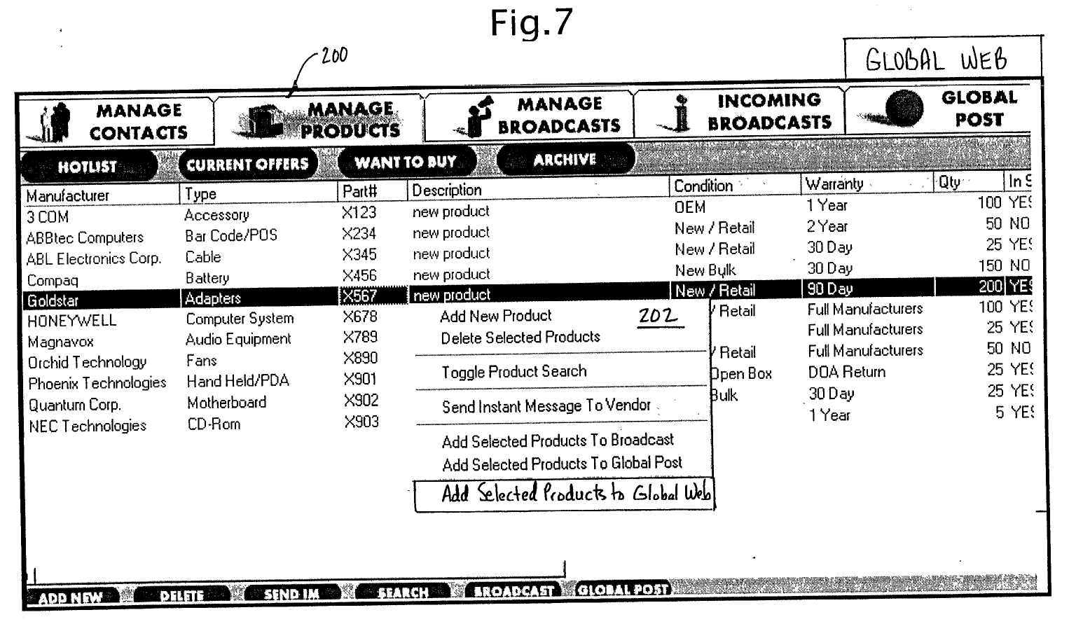

Referring to FIG. 7, the manage products folder 200 provides access to a “hotlist” screen, “current offers” screen, “want to buy” screen, and “archive” screen. The hot list folder 210 includes the description of products that a user desires to segregate for immediate action or special attention. The current offers screen includes the description of products that were “selected” by the user for potential resale or purchase. This is an outstanding tool for product and price comparisons. The want to buy screen includes the description of products that the user's customer's needs. The archive screen includes the description of every product received from an incoming broadcast. By highlighting and right-mouse clicking on a product description, a dropdown menu 202 is made available. The functions provided in the dropdown menu 202 include an add new product function, delete selected products function, toggle product search, send IM to vendor function, and add selected products to a broadcast, the global post folder 500, or the global web folder 600. Of course, a user has the option of selecting by highlighting more than one product at a time and applying an available function.

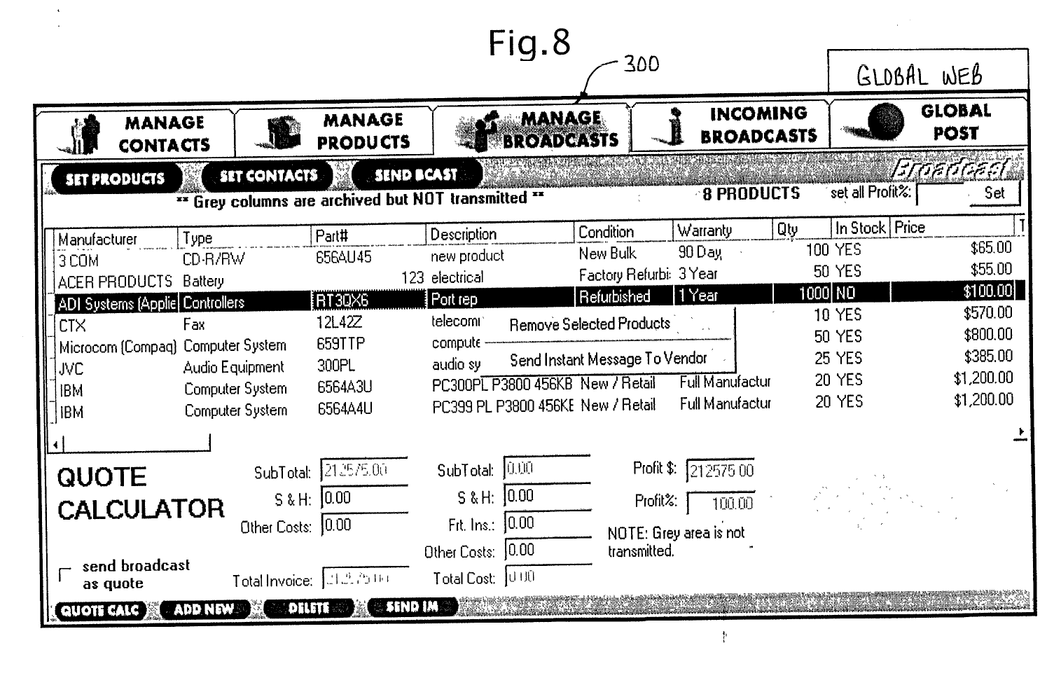

Referring to FIG. 8, the manage broadcasts folder 300 provides access to a “set products” screen, “set contacts” screen, and a “send broadcast” function. The set products screen enables a user to select one or more products from any screen in the manage products folder 200. To select a product, the user highlights desired products, right-mouse clicks on the highlighted products to open a dropdown menu, and selects the function “Add Selected Products to Broadcast.” (FIG. 7) The selected products are sent to the manage broadcasts folder 300. In the manage broadcasts folder 300, prices and profits can be calculated quickly in several ways: the user can type in the proposed price; type in the proposed profit percentage by line item or for the whole group of products; or type in the total price or total profit. Important product information can be attached to the product as a product note.

Each cell entry in the set products screen can be edited prior to sending the broadcast to a recipient. Several of the cells can be edited simply by editing the text in the cell (e.g., part number cell, description, and cost.) Other cells can be edited by opening dropdown menus that include selections from which a user can select. For example, dropdown menus are available for each individual cell in: the manufacturer column listing all computer equipment manufacturers (e.g., 3-Com, Compaq, and IBM); the type column listing all of the different equipment types sold in the industry (e.g., hard drives, audio equipment, and laptops); and the condition column listing all equipment conditions (e.g., new/retail, factory refurbish, and new open box.)

A detailed quote can be generated utilizing a “quote calculator” and transmitted with a broadcast. The quote may include shipping and other costs. A dropdown menu is available by highlighting and right-mouse clicking on a product. The dropdown menu includes functions for removing selected products and sending an IM to a vendor.

The set contacts screen enables a user to select individual contacts or groups from the manage contacts folder 100. To select a contact or group, the user highlights the selected contacts/groups in the manage contacts folder 100, right-mouse clicks on the highlighted contacts/groups to open a dropdown menu, and selects the function “Add Selected Contacts to Broadcast.” The selected contacts/groups are sent to the manage broadcasts folder 300.

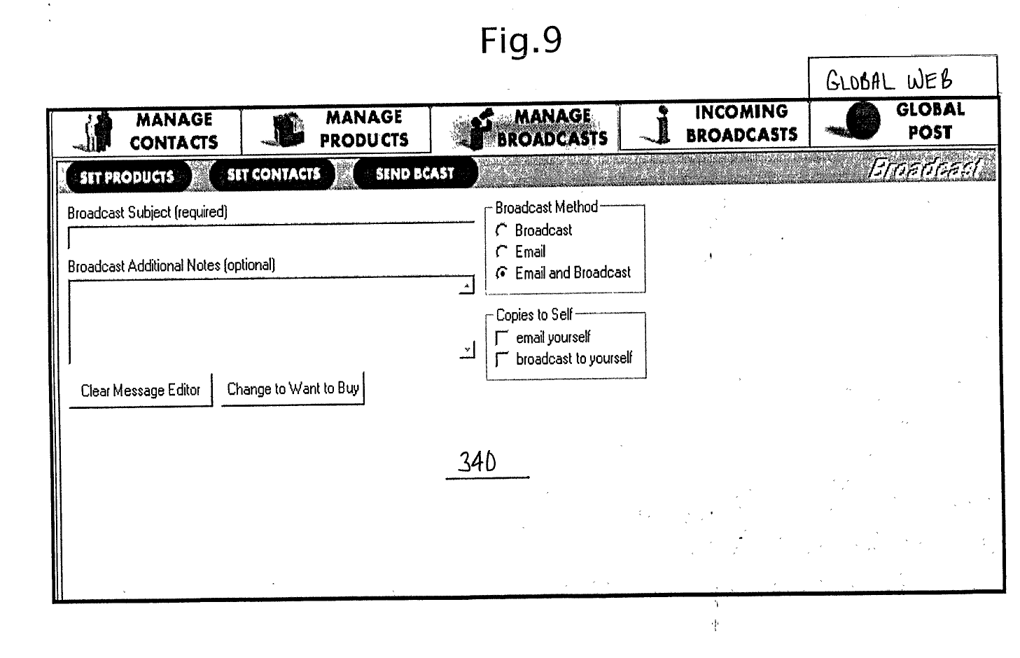

Referring to FIG. 9, after the products and contacts have been set, a broadcast can be sent by selecting the send broadcast function, at which time a send broadcast screen 340 is displayed. Using the send broadcast screen 340, a user enters a subject (required) and additional notes (optional.) The user then selects a broadcast type including either a standard broadcast for transmitting general product offers to one or many contacts/groups or a want-to-buy broadcast for transmitting a request for prices and availability of selected products. A broadcast method is then selected including either a broadcast message concerning electronic product offers to buy or sell to other users, an e-mail message which is a customized/formatted e-mail to one or many contacts/groups, or both. Both an e-mail and broadcast must be sent when the selected distribution list contains both users and non-users. All sent messages are archived in the user's broadcast archive database.

All transmitted broadcast messages are numbered, dated, and archived. Archiving provides a number of advantages. For example, archiving facilitates the ability to quickly determine to whom broadcast messages were sent, the date they were sent, the details of the sent broadcast message, etc. Such information is available in, for example, the archive screen in the manage products folder 200. Previously sent broadcast messages may be searched by, for example, product description, date of transmission, and broadcast message number.

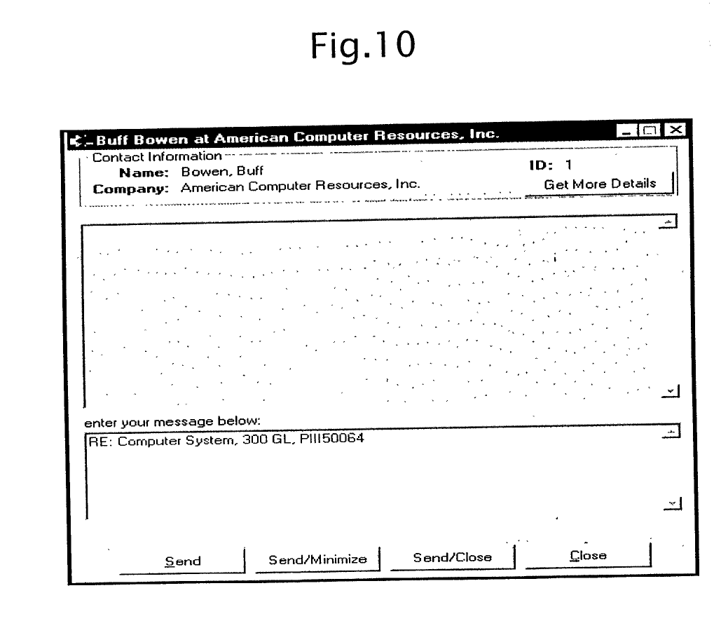

FIG. 10 illustrates the instant message feature of the present invention. This feature enables a user to transmit an instant message in a standardized database format (e.g., SQL). A message recipient can select all or part of the data in the instant message and transfer the selected data into their database. Each user retains an archive in his client of all instant messages that were sent and received by the user.

Non-users are not able to utilize the instant message feature because their clients do not include the client program. Instead, broadcast messages transmitted by users are translated into e-mail messages and, thereafter, transmitted to the non-user recipient as an e-mail.

The instant messaging system allows users to send/receive instant messages with any “authorized” contact in the user's contact database. Messages generated from highlighted products include the vendors name/company/id, as well as the original broadcast ID and the product information as originally sent by the vendor. All instant messages are archived for future reference.

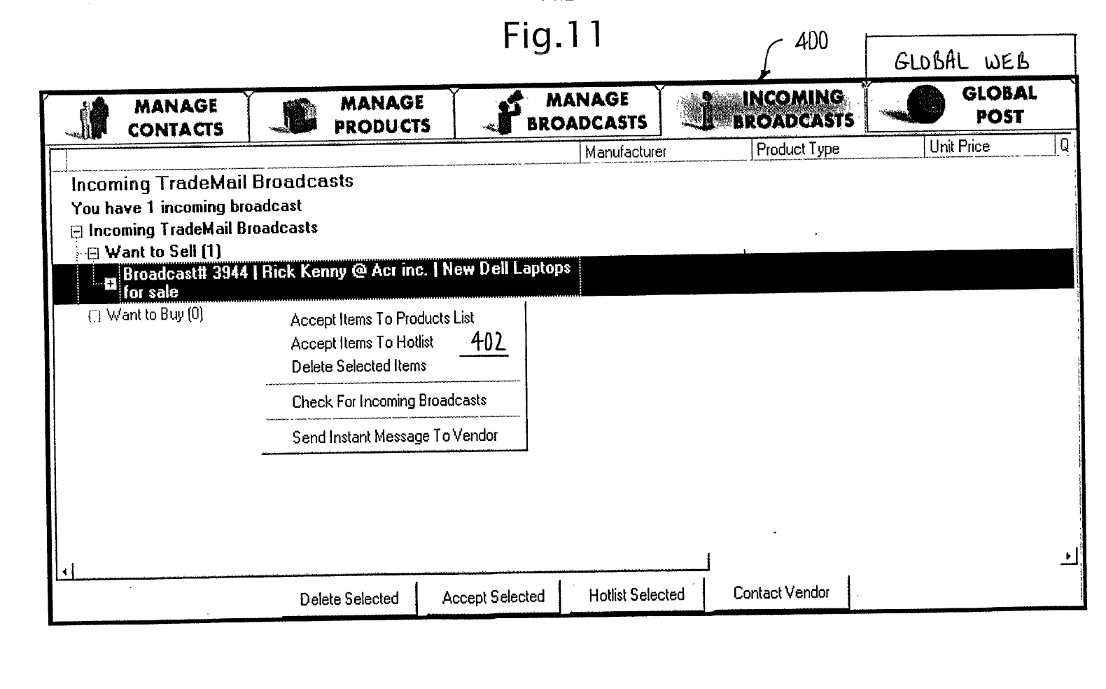

Referring to FIG. 11, all incoming broadcasts and want-to-buy messages come in through the incoming broadcast folder 400. Messages can be opened to view all products being sold or needed to buy. To expand and view messages the user clicks on the “+” signs and to minimize messages clicks on the “−” signs. To save/delete selected products the user highlights the desired products and clicks on “accept items to products list,” “accept items to hot list,” or “delete selected items.” All messages selected for storage in the hotlist database are automatically entered into the current offers database as well. All messages/products (whether selected or deleted) are automatically saved in the archive database in the manage products folder 200.

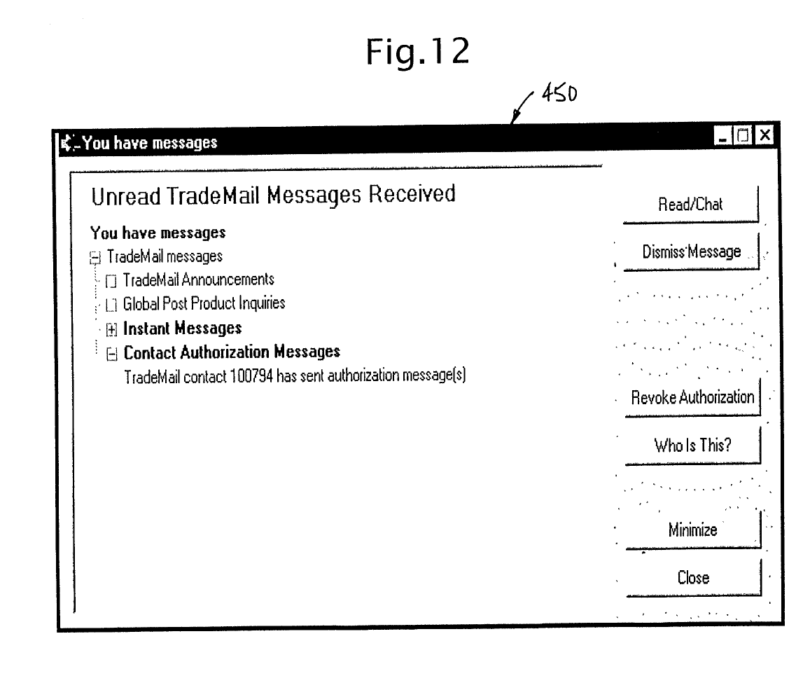

Referring to FIG. 12, when an IM is received by a user a “you have messages” window 450 will appear in the active folder. The window 450 may indicate receipt of a system announcement, global post product inquiry, message from another user, or request for a contact authorization. Messages can be opened by double-clicking on the message. For example, when a user opens an “instant message,” an IM communication window similar to that illustrated in FIG. 10 opens with the sender's message displayed therein. As a further example, when a user opens a contact authorization message, an authorization request similar to that illustrated in FIG. 6 opens. When a message is highlighted, functions appear along the right-hand border for responding to the message in a more expedient manner.

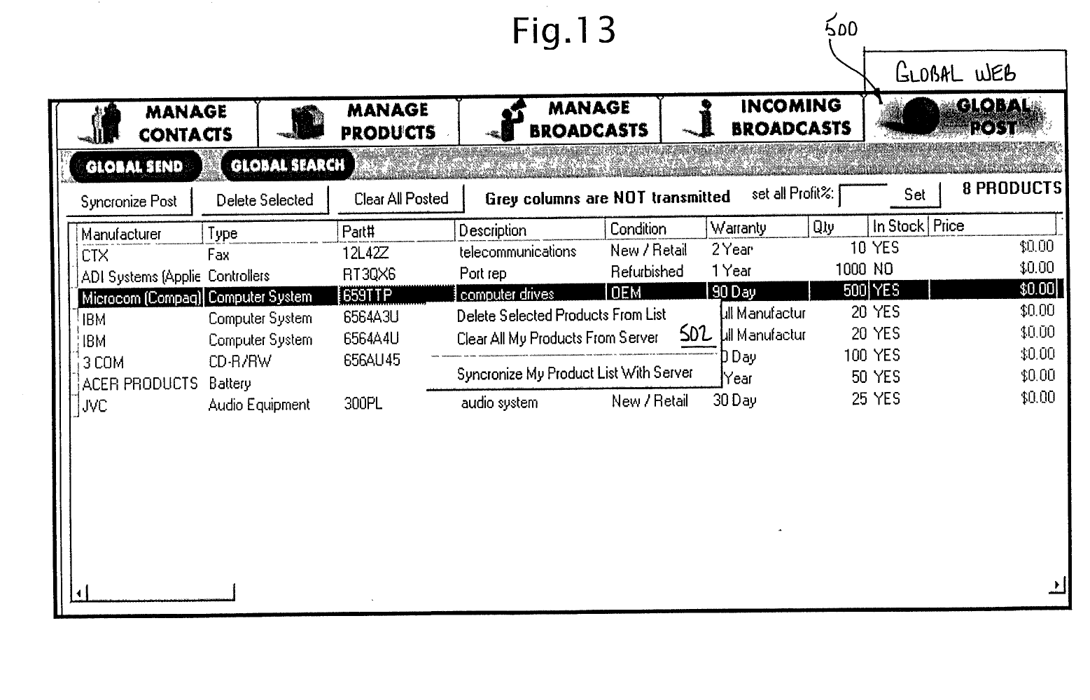

Referring to FIG. 13, the global post component includes the global post folder 500 having a “global send” screen and a “global search” screen. The global send screen includes a “synchronize post” function, “delete selected” products function, and “clear all posted” products function. By adding products to the global send screen and activating the synchronize post function, a user can conveniently send products to the database 16 in the central server cluster 14 where other users can search for and view the posted products. A user can use this feature in conjunction with or instead of broadcasting his products to selected contacts.

Conveniently, a user can post one or more products in the global post folder 500 by, for example, opening the manage products folder 200, high-lighting one or more products that he wants to send to the global post folder 500, and either right-mouse clicking on the highlighted product to open a dropdown menu 202 and selecting the “add selected products to global post” function, or selecting the “global post” control function at the bottom of the manage products folder 200. It is notable that the products in the global post folder 500 remain in the database 16 until the user edits the global post folder and clicks on the synchronize post function. A dropdown menu 502 including the three above-described functions is available by highlighting and right-mouse clicking on a product.

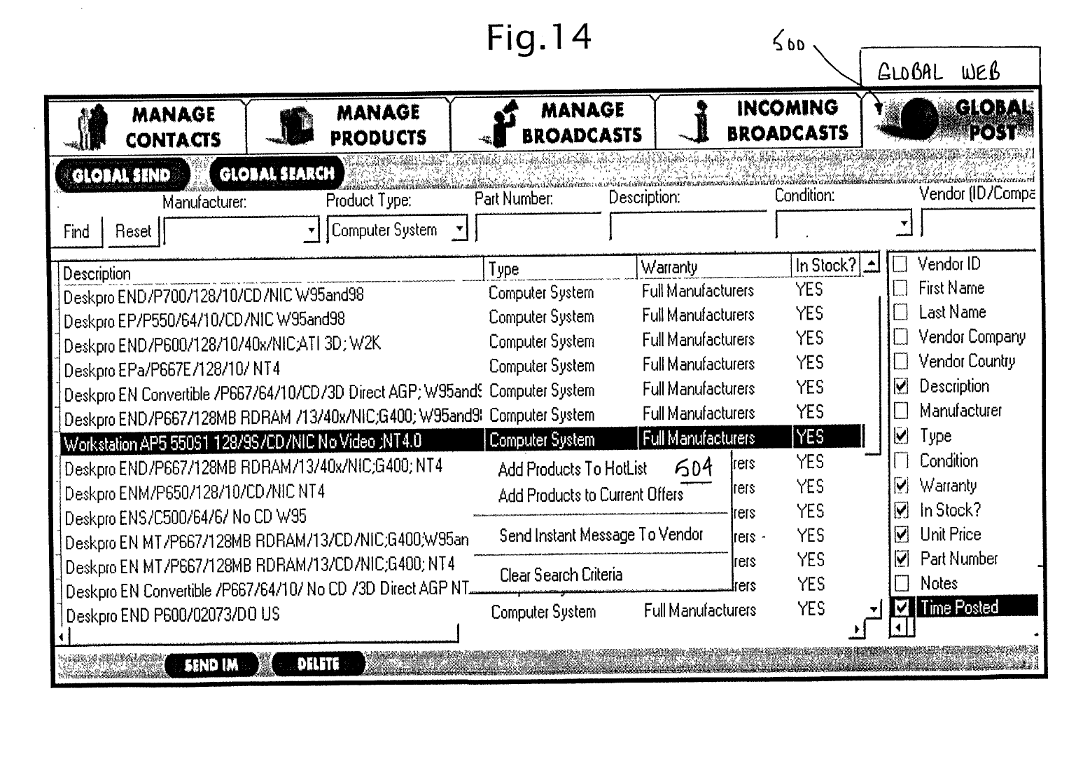

Referring to FIG. 14, by selecting the global search screen, a user can search all users' posted product offerings utilizing one or more search fields. To do so, the user activates the global search screen, enters a query, and activates the “find” function. The query may include, for example, a name of a manufacturer, product type, part number, description, condition and a vendor ID or name. A dropdown menu 504 is available by highlighting and right-mouse clicking on a product. The dropdown menu 504 includes the functions “add products to hot-list,” “add products to current offers,” “send instant message to vendor,” and clear search criteria.”

The global web component includes a global web folder 600 that operates in a manner similar to the global post folder 500 except that it populates a server-managed web site that is accessible to anyone that has access to the Internet (“Internet user”.) E-mails received from an Internet user can be received by a user in the form of an e-mail or converted to an IM, the latter allowing the user to save, instantly respond (e.g., prepare a quote and e-mail using functions in the manage broadcasts folder 300), and archive all incoming and outgoing messages. It is anticipated that this feature can be adapted to function with the user's own web site.

Although not illustrated, each screen also includes advertising banners for presenting advertisements to users. The manner in which the banners are retrieved and presented is unique in the art. More specifically, when a user first opens the main menu, the client calls to the server to retrieve a banner for each banner location. At certain predetermined intervals, for example, every thirty-seconds, the client calls the server to retrieve and transmit banners to the client for presentation on the main menu. Furthermore, the refreshing process is discontinued after a predetermined amount of time if the user has not used the client for a predetermined amount of time or if the client software has been minimized by the user. Those skilled in the art will recognize this as a significant improvement over the prior art in that present systems do not differentiate between an idle user or a minimized screen. This is particularly advantageous since if the banners were to rotate through during idle user time or a minimized screen an advertiser would be paying for advertisements when it could not be viewed.

The client program may also provide management capabilities. More specifically, the client program may include a reporting feature that would report, for example, the following about a salesman's use of the system: date the salesman's client program was installed, number of contacts in the database, number of broadcasts/quotes sent, number of recipients that received broadcasts/quotes, the number of broadcasts/quotes received, and a description of the products included in broadcast messages. This provides such sales managers a tool for measuring the accomplishments of his sales force. Reports may be printed according to a predefined schedule.

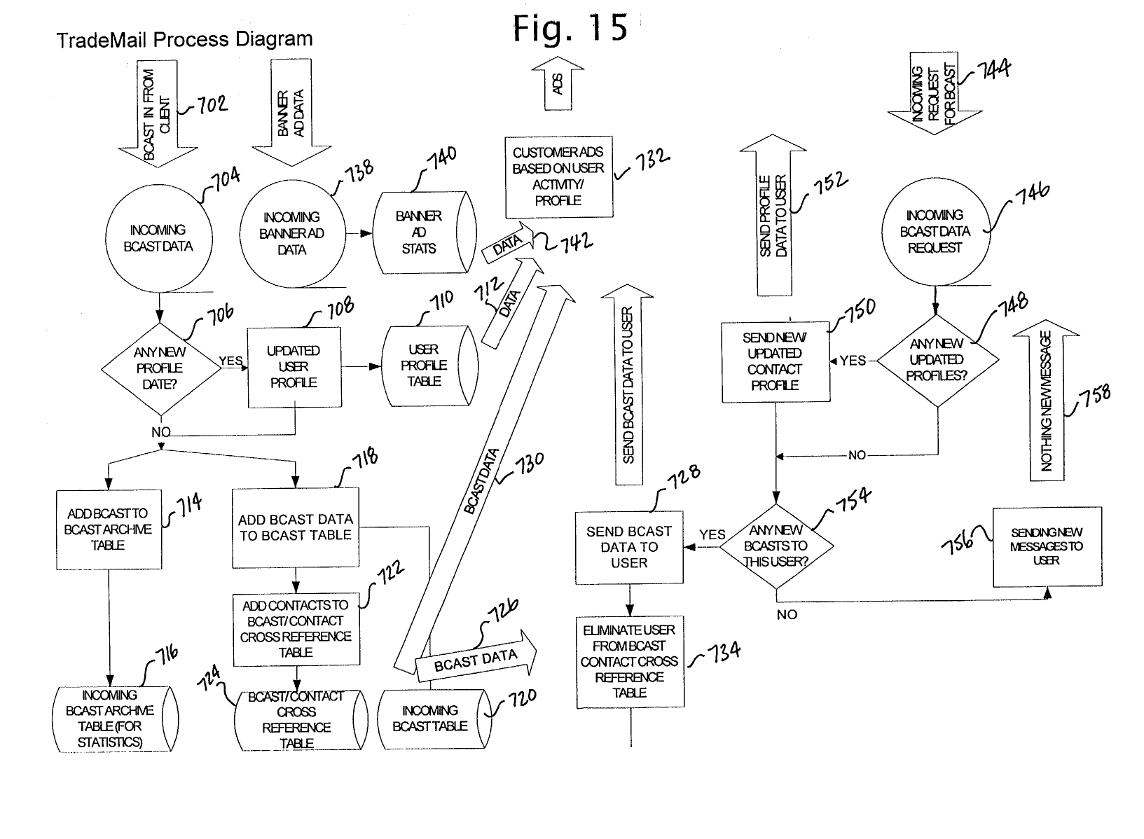

Referring to FIG. 15, a process diagram for the server program is illustrated. At step 702, a broadcast is received from a client including a message identifying one or more products a user selected to buy or sell. At step 704 the incoming broadcast data is stored. The incoming broadcast data includes, for example, company profiles and product offers. At step 706, the server program determines whether there is new profile data. If there is new profile data, the user profile is updated at step 708. At step 710, the user profile is updated on the server. At step 712, the data is transmitted to an ad banner program allowing banners to be selected that match the new profile.

At step 714, the broadcast data is added to a broadcast archive table for statistical analysis and backup. At step 716, the broadcast data is stored in an incoming broadcast archive table for statistical purposes. At step 718, the server program directs the broadcast data to be stored in the incoming broadcast table and, at step 720, the broadcast data is stored in the incoming broadcast table. At step 722, the server program adds contacts to the broadcast/cross-reference table and, at step 724, the contacts are stored to the broadcast/cross-reference table.

At step 726, a link is provided for transmitting broadcast data from step 724 to step 728, and at step 730, a link is provided for transmitting broadcast data from step 724 to step 732. The broadcast data is stored until it can be received by an end user. At step 734, after the broadcast data is sent to the user, the user's name is deleted from the broadcast/contact cross-reference table at step 724. At step 732, the server program determines the banner ads and, based on what the client wants, it allows the banners to be product specific.

At step 736, banner ad data is received from an advertiser. At step 738, the banner ad data is stored. At step 740, the banner server matches the banner ads with product offers and profiles. At step 742, a data link is provided to transmit information to a user based on the user's profile. At step 732, custom banner ads are transmitted to the user based on a user's profile and broadcast activity.

At step 744, the server program receives a request for the distribution of a broadcast. At step 746, the server program stores the request in storage. At step 748, the server program determines whether any new or updated profiles have been received. If, at step 748, new or updated profiles have been received, then the profile is updated at the server and sent to the user with the change of information. For example, the profile will be updated if an e-mail address, phone number, or street address has been changed.

At step 750, the server program prepares to send the new/updated contact profile. At step 752, the profile data is sent to the user. This is an automatic download process for the user about his groups. It is preferable that this download is transmitted with a product broadcast list only. At step 754, the server program determines whether there are any new broadcasts to the user. If there are new broadcasts to the user, then the server program links to step 728 and sends the new broadcasts to the user. At step 734, the server program goes to step 724 and deletes the user from the broadcast/contact cross-reference table.

If, at step 754, the server program determines that a new broadcast has not been received, then a message is queued for transmission indicating that a new broadcast has not been received. At steps 756 and 758, respectfully, the message is prepared and transmitted to the user.

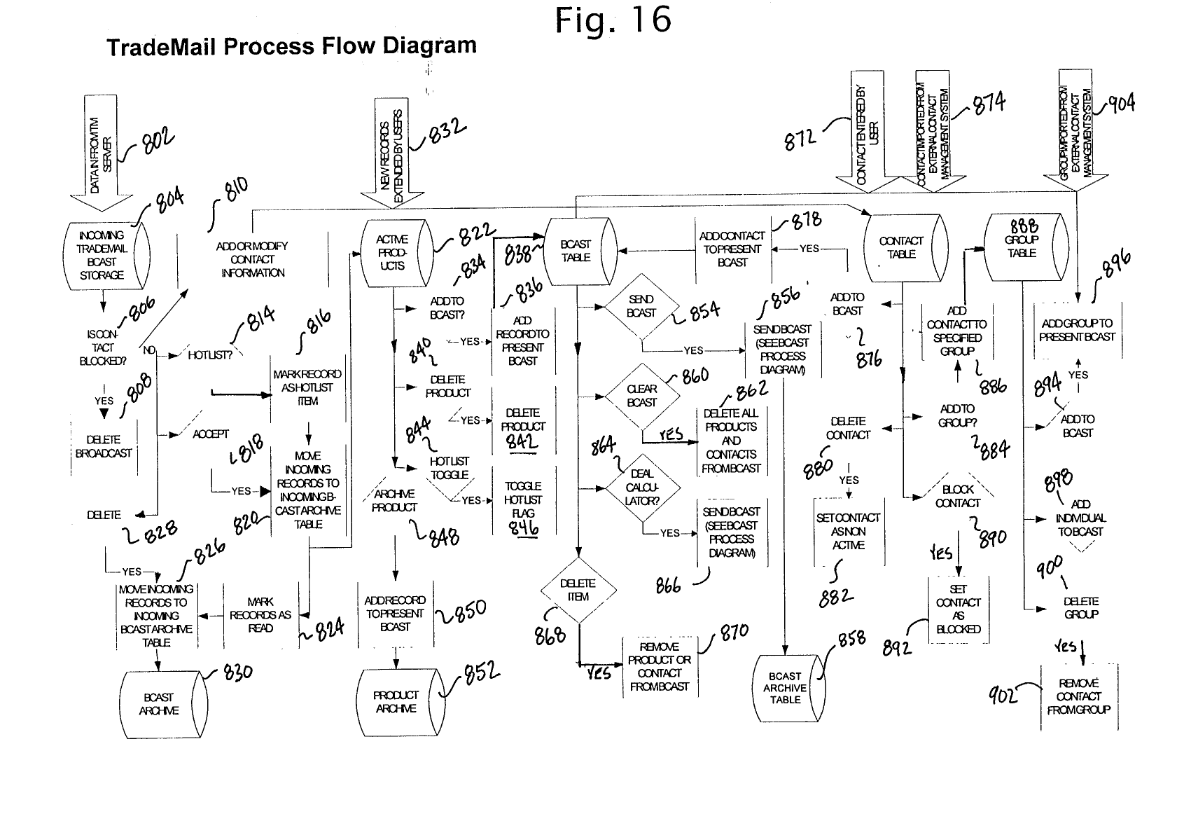

Referring to FIG. 16, a process flow diagram for the client program is illustrated. At step 802, the client program receives a broadcast message from the server program. At step 804, the broadcast message is stored in storage. At step 806, the client program determines whether the contact is authorized. If the contact information is not authorized, then, at step 808, the broadcast message is deleted. If the contact is authorized, then, at step 810, the contact information in the broadcast is added or modified in a contact table at 812.

In addition, if the contact information is authorized, then, at step 814, the client program determines whether the user desires to store the associated product in the hot-list database. If the product is to be stored in the hot-list database, then, at step 816, the item is marked as a hot-list item. In addition, if the contact information is authorized, then, at step 818, the client program determines whether the user selected to save the incoming broadcast message. At step 820, the client program saves the incoming broadcast message in the incoming broadcast archive table and, at step 822, saves the incoming broadcast message in the active products storage. At step 824, the item is marked as “read” and proceeds to step 826.

If, at step 818, the broadcast message is not accepted, then, at step 828, the broadcast message is deleted and the client program proceeds to step 826. At step 826, the client program moves incoming items to the incoming broadcast archive table. Thereafter, at step 830, the data is saved to the broadcast archive.

At step 832, a new item is entered into the client program by the user and stored, at step 822, in the active products storage. At step 834, the client program determines whether the user selected to add the entered item to a broadcast message. The user may also add items from the hot-list or accepted items list. At step 836, the item is added to the broadcast message and the hot-list and accepted items list can be added to the broadcast table at step 838.

Alternatively, at step 840, the client program determines whether the user selected to delete a product from storage. If a product is to be deleted from storage, then, at step 842, the product is in fact deleted from storage. Alternatively, at step 844, the client program determines whether the client selected to identify an item as a hot-list item. Doing so will identify the item as an item that the user is interested taking further action on. If an item is to be identified as a hot-list item, then, at step 846, the item is flagged as a hot-list item. Alternatively, at step 848, the client program determines whether the user selected to archive a product. If a product is to be archived, then, at step 850, the product may be added to the present broadcast message and, at step 852, the product is stored as an archive product. Such data is searchable as a “current” product.

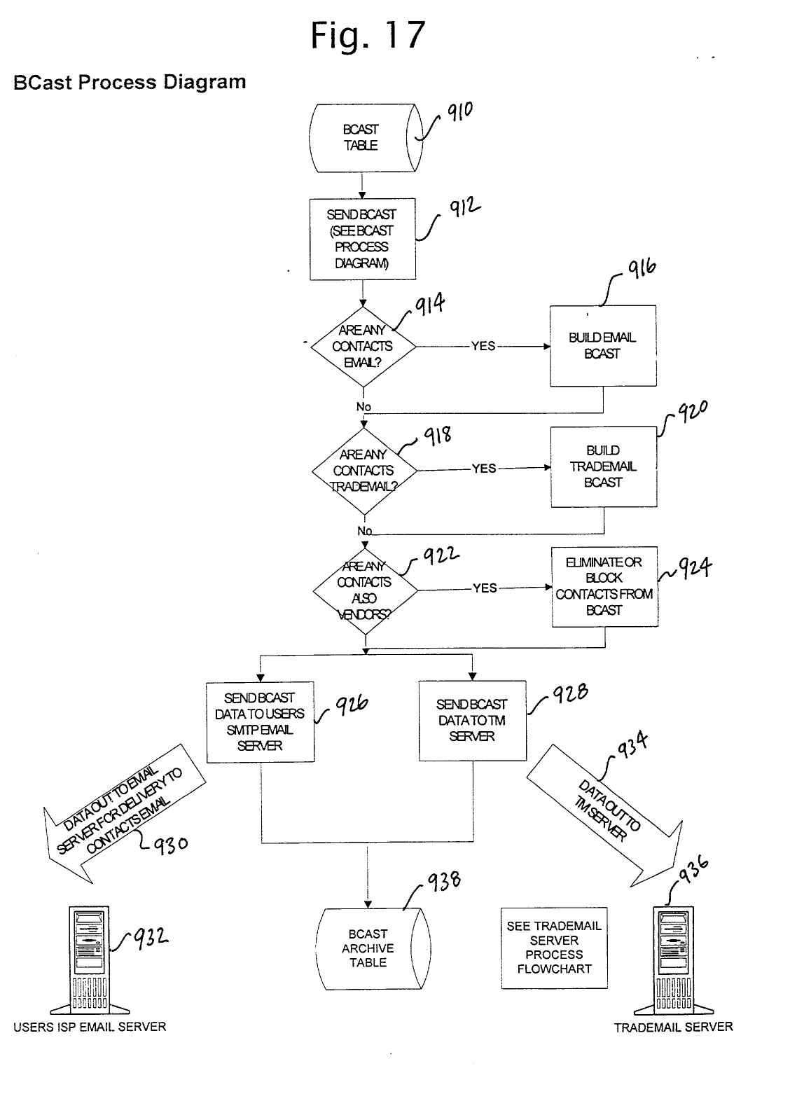

At step 838, data is collected and temporarily stored in the broadcast table while information is being gathered before being sent out. At step 854, the client program determines whether the broadcast message is to be sent out. If the broadcast message is to be sent out, then, at step 856, the broadcast message is sent to the indicated contacts as described below and illustrated in FIG. 17. At step 858, the sent broadcast message is archived in the broadcast archive table.

At step 860, the client program determines whether all contacts and products are to be cleared from a broadcast message. If all contacts and products are to be deleted, then, at step 862, all contacts and products are deleted from the broadcast message. At step 864, the client program determines whether the user selected to calculate his cost-profit and create a quote based thereon. If so, then, at step 866, the user calculates his cost-profit, creates a quote, and sends it to a customer as illustrated below in FIG. 17.

At step 868, the client program determines whether any individual contacts or products are to be deleted from a broadcast message. If any individual contacts or products are to be deleted, then, at step 870, the user selects individual contacts and products that are to be deleted from the broadcast message and the client program deletes the individual contacts or products from the selected broadcast message.

At step 872, a contact is entered by a user, while at step 874, contact information is imported from an external contact management system. At step 812, the contact information is stored in the contact table. At step 876, the client program determines whether the user selected to add the contact to a broadcast message. If so, then, at step 878, the contact is added to the broadcast message and the program proceeds to step 838.

At step 880, the client program determines whether the user selected to delete a contact. If so, then, at step 882, the contact is set as non-active. At step 884, the client program determines whether the user selected to add selected contacts to a group. If so, then at step 886, the selected contacts are added to the group and, at step 888, stored in a group table. At step 890, the client program determines whether the user authorized transmission of messages from a particular contact. If so, then, at step 892, the program sets the contact as unauthorized, thereby preventing the user from automatically receiving a broadcast from the contact.

At step 894, the client program determines whether the user selected to add a group to a broadcast message. If so, then, at step 896, the user selects a group and a broadcast message and the group is added to a selected broadcast message. At step 898, the client program determines whether the user selected to add an individual contact to a broadcast message. If so, then the user selects an individual contact and a broadcast message and the individual contact is added to the selected broadcast message. At step 900, the client program determines whether the user selected to delete an individual contact from a contact group or a contact group from the group table. If so, then, at step 902, the user selects the individual contact or group and it is deleted from the group table. Contacts in imported groups 904 are treated the same as individual contacts.

Referring to FIG. 17, a broadcast process diagram is illustrated. At step 910, the client program stores broadcast data in a broadcast table. At step 912, the client program sends a broadcast message to a recipient user or non-user. The broadcast information includes information indicating the sending user's intent to buy or sell goods. At step 914, the client program determines whether any of the broadcast messages are to be sent via e-mail. If so, then the client program proceeds to step 916. At step 916, the client program builds an e-mail broadcast message. A broadcast message is now ready to be sent via email to a user or non-user. Thereafter, the client program proceeds to step 918. If, at step 914, the client program determines that none of the broadcast messages are to be sent via e-mail, then the program proceeds directly to step 918.

At step 918, the client program determines whether any of the broadcast messages are to be sent via the server. If a broadcast message is to be sent via server, then the client program proceeds to step 920. At step 920, the client program builds a broadcast message. The broadcast message is now ready to be sent via the server. Thereafter, the client program proceeds to step 922. If, at step 918, the client program determines that none of the broadcast messages are to be sent via e-mail, then the program proceeds directly to step 922.

At step 922, the client program determines whether any of the broadcast messages are to be sent to vendors. If a broadcast message is to be sent to a vendor, then the client program proceeds to step 924. At step 924, the client program eliminates vendors from receiving the broadcast message. Thereafter, the client program proceeds to either step 926 or step 928. If, at step 922, the client program determines that none of the broadcast messages are to be sent to a vendor, then the program proceeds directly to either step 926 or 928.

If the broadcast message is to be transmitted via e-mail, the client program proceeds to step 926 and prepares the broadcast message for transmission to sender user's SMTP e-mail server. At step 930, the broadcast message is transmitted to the e-mail server for delivery to the recipient. At step 932, the broadcast message is received by the user's ISP e-mail server and, thereafter, transmitted to the recipient.

The e-mail may be formatted to include a link that the recipient may click on to retrieve a template. As the template is retrieved, it is filled in to include the information in the original e-mail. The recipient may modify the template as desired, for example, to include the addresses of additional users to receive it, include an offer to buy or sell the items in the e-mail, add additional items to the offer to buy or sell, etc. After the template is completed, the recipient sends the template message and it is automatically converted to the broadcast message format and is returned to the sender user. If the recipient included additional addresses, the template will be forwarded to the additional addresses.

If the broadcast message is to be transmitted via the server, the client program proceeds to step 928 and prepares the broadcast message for transmittal to the server. At step 934, the broadcast message is transmitted to the server for delivery to the recipient. At step 936, the broadcast message is received by the server and, thereafter, transmitted to the recipient. At step 938, the broadcast message is stored in the user's archive table.

It is anticipated that a personal digital assistant (“PDA”) may advantagiously function with the system. In one version, a user can synchronize his PDA and data will be dumped back and forth between the PDA and the user's client program. This version allows the user to generally sift through his products and produce a broadcast message. When the PDA is resynchronized, the broadcast message is loaded on the client and transmitted to the recipients. Another version functions as described above, however, the PDA transmits data via wireless transmission. Platforms that may be utilized in such a system include, for example, PalmOS® (Palm, Inc., Santa Clara, Calif.) and WinCE® (Microsoft Corp., Redmond, Wash.).

While the system and method for detecting defects has been described with respect to various specific embodiments (e.g., paper mottle and print mottle), those of ordinary skill in the art will readily appreciate that various modifications, changes, and enhancements may be made thereto without departing from the spirit and scope of the invention as defined by the appended claims.

While the system and method for conducting business-to-business has been described with respect to various specific embodiments, those of ordinary skill in the art will readily appreciate that various modifications, changes, and enhancements may be made thereto without departing from the spirit and scope of the invention as defined by the appended claims.

What is claimed is:

1. A method for conducting business-to-business communications over a computer network, comprising:
entering one or more contact descriptions into a contact database;
entering one or more product descriptions into a product database;
associating the one or more contact descriptions and one or more product descriptions in a broadcast message;
entering pricing and quantity data for the one or more product descriptions into the broadcast message; and
transmitting the broadcast message over the network to the one or more contacts.

2. A method as recited in claim 1, wherein the step of entering one or more contact descriptions into a contact database comprises entering descriptive information selected from the group comprising contact name, company name, mailing address, phone number, e-mail address, and URL.

3. A method as recited in claim 1, wherein the step of entering one or more product descriptions into a product database comprises entering descriptive information selected from the group comprising manufacturer, type, part number, description, condition, warranty, quantity, availability, and price.

4. A method as recited in claim 1, further including the step of creating a contact group and associating the one or more contact descriptions with the contact group.

5. A method as recited in claim 1, wherein the step of entering pricing and quantity data for the one or more product descriptions includes setting a profit percentage for the one or more product descriptions.

6. A method as recited in claim 1, wherein the contact database and the product database are in a storage of a client computer.

7. A method for conducting business-to-business communications over a computer network, comprising:
entering a first set of product descriptions into a database on a client computer programmed with a client program;
receiving a second set of product descriptions over a network from a posting database in communication with a server computer programmed with a server program, wherein the second set of product descriptions are available for modification by the client only, but available for viewing by other client computers programmed with the client program;
associating the first set of product descriptions with the second set of product descriptions; and
transmitting the associated first and second sets of product descriptions over the network for storage in the posting database of the server computer.

8. A method as recited in claim 7, wherein the step of entering a first set of product descriptions into a product database comprises entering descriptive information selected from the group comprising manufacturer, type, part number, description, condition, warranty, quantity, availability, and price.

9. A method as recited in claim 7, wherein the associated first and second sets of product descriptions are available for viewing by other client computers over the Internet only.
